(19) United States
(12) Patent Application Publication
(10) Pub. No.: US 2026/0077763 A1
(43) Pub. Date: Mar. 19, 2026

(54) MONITORING SYSTEM FOR A VEHICLE

(71) Applicant: GM Global Technology Operations LLC, Detroit, MI (US)

(72) Inventors: Alec M. Wuorinen, Columbus, OH (US); Craig Thomas Douglas, Pflugerville, TX (US); Matthew Edward Gilbert-Eyres, Rochester Hills, MI (US)

(73) Assignee: GM Global Technology Operations LLC, Detroit, MI (US)

(21) Appl. No.: 18/884,733

(22) Filed: Sep. 13, 2024

(51) Int. Cl. B60W 30/095; B60W 50/14; G06V 20/58

(52) U.S. Cl. CPC B60W 30/0956; B60W 50/14; G06V 20/58; B60W 2050/146

(57) ABSTRACT

A monitoring system for a vehicle includes data processing hardware and memory hardware in communication with the data processing hardware. The memory hardware stores instructions that when executed on the data processing hardware cause the data processing hardware to perform operations. The operations include monitoring, via a monitoring application for a vehicle, one or more secondary vehicles, capturing, via an image sensor, occupant data and blind spot data, and receiving, via a back-office server, crowdsourced data. The operations also include monitoring, via the monitoring application, the occupant data, the blind spot data, and the crowdsourced data, generating, based on the occupant data, the blind spot data, and the crowdsourced data, a score via a scoring function of the monitoring application, and generating, via a prediction function of the monitoring application, a prediction notification based on the score.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a monitoring system for a vehicle.

Vehicles are often equipped with various sensors and assistance functions to aid a driver during operation of the vehicle. For example, vehicles are equipped with turn signals that provide information to surrounding vehicles that the vehicle intends to make a turn, lane change, or other maneuver that may affect the surrounding vehicles. In some instances, turn signals may be executed for only a short duration of time, such that an operator of a nearby vehicle may not observe the turn signal prior to the notifying vehicle executing a maneuver. Vehicles are often, but not always, equipped with blind spot monitoring features that provide an indication to a driver that a nearby vehicle may be in a position that is out of view of the driver. While visually available to the operator of the vehicle equipped with the blind spot monitoring, drivers of nearby vehicles may be unaware they are in a blind spot of another vehicle.

In further instances, quick maneuvers may occur where merge lanes and/or off-ramps are shortened. For example, a driver may make a late maneuver to gain access to an on-ramp or an off-ramp, such that there may be a rapid lane change unanticipated by nearby vehicles. While drivers are often cognizant of surrounding vehicles and behaviors of drivers, it is possible to overlook certain behaviors or be unable to anticipate maneuvers that may contradict otherwise standard driving. Thus, there is a need for improved monitoring to assist drivers in maneuvering on roadways and monitoring other vehicle behaviors to further improve road safety.

### SUMMARY

In some aspects, a monitoring system for a vehicle includes a plurality of sensors configured to capture sensor data, a navigation application including navigation data, an infotainment unit including a display, and a controller communicatively coupled with each of the plurality of sensors, the navigation application, and the infotainment unit. The controller includes data processing hardware configured to execute a monitoring application based at least one of the sensor data and the navigation data. The monitoring application is configured to monitor a detection zone of the vehicle for one or more surrounding vehicles and is configured to predict a lane change of the one or more surrounding vehicles. The monitoring application is also configured to issue an alert at the display of the infotainment unit in response to the predicted lane change.

In some examples, the monitoring application may include a blind spot monitoring function that is configured to determine the vehicle is positioned within a blind spot of the one or more surrounding vehicles based on the sensor data. The monitoring application may be configured with an occupant monitoring function. The occupant monitoring function may be configured to detect a movement of an occupant of the one or more surrounding vehicles based on the sensor data. Optionally, the monitoring application may be configured to issue the alert based on at least one of the blind spot monitoring function and the occupant monitoring function. In some instances, the monitoring application may be configured to issue the alert in response to a detected surrounding vehicle and the navigation data. The navigation data may include an exit area of a roadway.

In other examples, the monitoring application may be configured to monitor a lane change behavior of the one or more surrounding vehicles and determine the predicted lane change based on the monitored lane change behavior. Optionally, the controller may be communicatively coupled with a back-office server and may be configured to receive crowdsourced data from the back-office server. The crowdsourced data may include at least one of lane change areas and vehicle movements. In some instances, the plurality of sensors may include an image sensor and the sensor data includes image data.

In another aspect, a computer-implemented method when executed by data processing hardware causes the data processing hardware to perform operations. The operations include monitoring, via a monitoring application for a primary vehicle, one or more secondary vehicles, capturing, via an image sensor, occupant data and blind spot data, receiving, via a back-office server, crowdsourced data, and monitoring, via the monitoring application, the occupant data, the blind spot data, and the crowdsourced data. The operations also include issuing, via the monitoring application, a low-level alert based on the blind spot data and notifying a driver of the primary vehicle that the primary vehicle is in a blind spot of the one or more secondary vehicles, generating, based on the occupant data, the blind spot data, and the crowdsourced data, a score via a scoring function of the monitoring application, and generating, via a prediction function of the monitoring application, a prediction notification based on the score.

In some examples, generating the prediction notification may include predicting a lane change of the one or more secondary vehicles independent of turn indicators. Optionally, generating the score may include evaluating score factors, the score factors including one or more of repeated lane changes, an approach speed, navigation data, and the crowdsourced data. In some instances, the crowdsourced data may include technological capabilities of the one or more secondary vehicles, identified erratic vehicles, and frequency data of exit areas of a roadway. Optionally, generating the score may include determining a likelihood of the one or more secondary vehicles executing a lane change independent of turn indicators. In other examples, monitoring the occupant data may include monitoring a head movement and gaze direction of an occupant of the one or more secondary vehicles.

In further aspects, a monitoring system for a vehicle includes data processing hardware and memory hardware in communication with the data processing hardware. The memory hardware stores instructions that when executed on the data processing hardware cause the data processing hardware to perform operations. The operations include monitoring, via a monitoring application for a vehicle, one or more secondary vehicles, capturing, via an image sensor, occupant data and blind spot data, and receiving, via a back-office server, crowdsourced data. The operations also include monitoring, via the monitoring application, the occupant data, the blind spot data, and the crowdsourced data, generating, based on the occupant data, the blind spot data, and the crowdsourced data, a score via a scoring function of the monitoring application, and generating, via a prediction function of the monitoring application, a prediction notification based on the score.

In some examples, generating the prediction notification may include predicting a lane change of the one or more secondary vehicles independent of turn indicators. Optionally, generating the score may include evaluating score factors. The score factors may include one or more of repeated lane changes, an approach speed, navigation data, and the crowdsourced data. Optionally, the crowdsourced data may include technological capabilities of the one or more secondary vehicles, identified erratic vehicles, and frequency data of exit areas of a roadway. In some instances, generating the score may include determining a likelihood of the one or more secondary vehicles executing a lane change independent of turn indicators. In other examples, monitoring the occupant data may include monitoring a head movement and gaze direction of an occupant of the one or more secondary vehicles.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a monitoring system according to the present disclosure in communication with a back-office server via a network;

FIG. 2 is an example block diagram of a monitoring system according to the present disclosure;

FIG. 3 is an exemplary schematic of a vehicle and a surrounding vehicle on a roadway, the vehicle equipped with a monitoring system according to the present disclosure;

FIG. 4 is partial perspective view of an infotainment unit of a vehicle according to the present disclosure displaying an information notice;

FIG. 5 is another exemplary schematic of a vehicle and a surrounding vehicle on a roadway with an exit, the vehicle equipped with a monitoring system according to the present disclosure;

FIG. 6 is an exemplary flow diagram of a monitoring system according to the present disclosure; and

FIG. 7 is another exemplary flow diagram of a monitoring system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

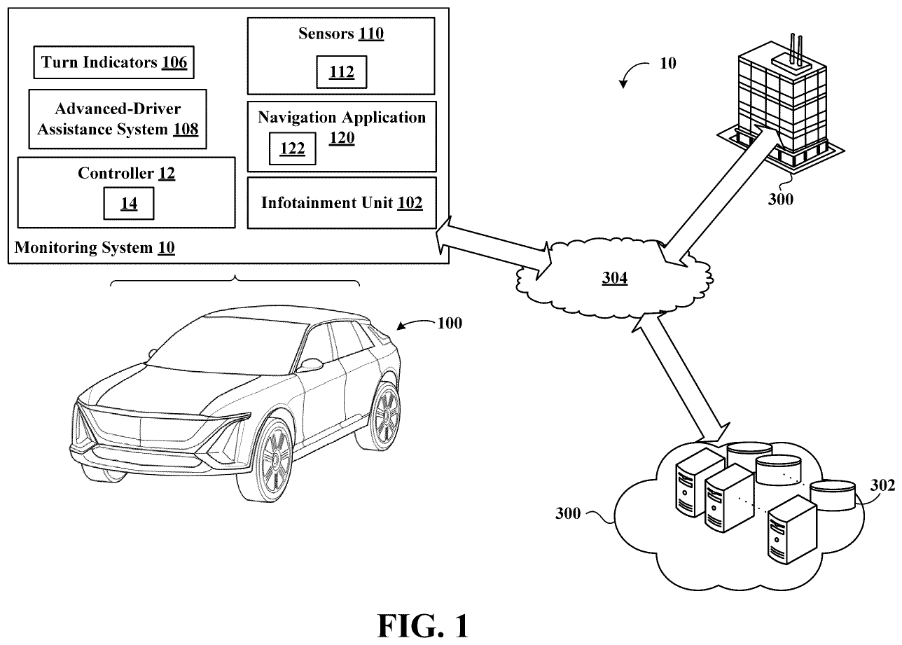

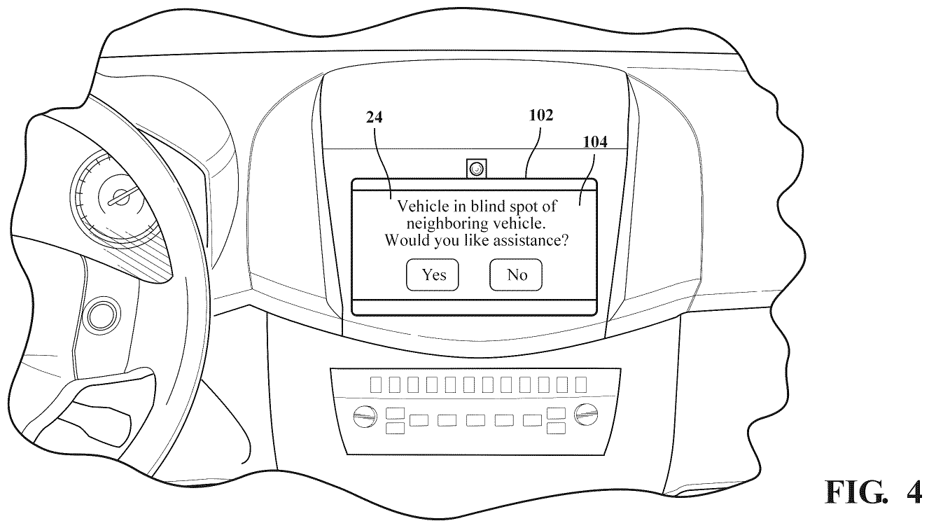

Referring to FIGS. 1-4, a primary vehicle 100 is equipped with a monitoring system 10 that includes a controller 12 equipped with a monitoring application 14. The controller 12 is communicatively coupled with an infotainment unit 102 of the primary vehicle 100 that includes a display 104 configured to display information notices 16 generated by the monitoring application 14, described in more detail below. The controller 12 is also communicatively coupled with a plurality of sensors 110 and a navigation application 120 of the primary vehicle 100. The plurality of sensors 110 are configured to capture sensor data 112 and may include, but are not limited to, an image sensor 110. For example, the sensor data 112 may include image data 112. The monitoring application 14 is configured to receive and monitor the sensor data 112 from the sensors 110 and navigation data 122 from the navigation application 120, as described in more detail herein.

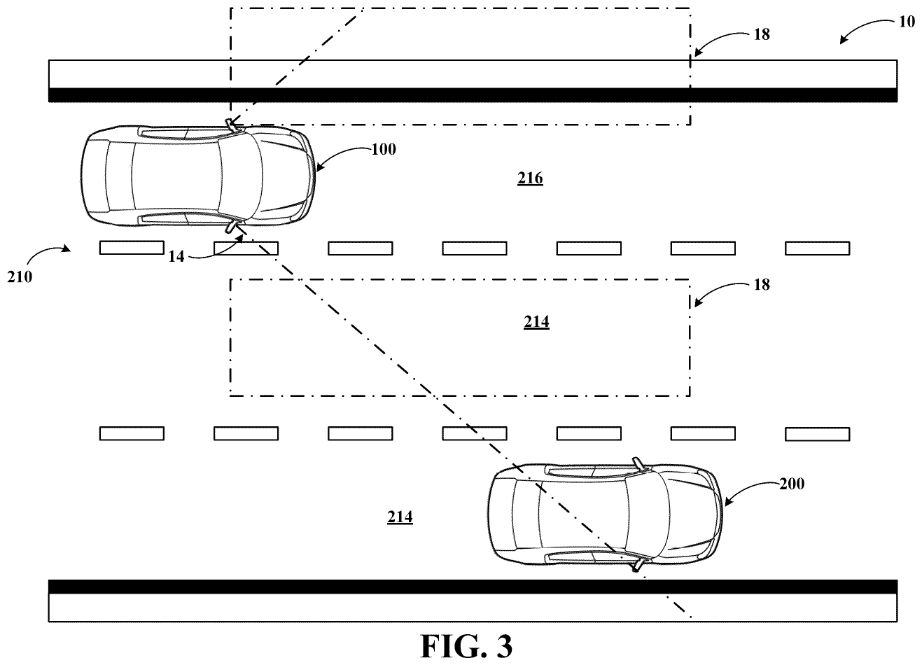

The monitoring system 10 is utilized by the primary vehicle 100 to detect surrounding, or secondary, vehicles 200 along a roadway 210 during operation of the primary vehicle 100. The secondary vehicles 200 are generally defined within a predefined proximity of the primary vehicle 100. The predefined proximity is defined as part of the monitoring application 14 and may be referred to as a detection zone 18 of the primary vehicle 100. The detection zone 18 is illustrated as forward of the primary vehicle 100 in FIG. 3. However, it is contemplated that the detection zone 18 may be defined rearward of the vehicle 100 in addition to forward of the primary vehicle 100. For example, the detection zone 18 may be utilized to detect erratic or other driving patterns. The monitoring application 14 is configured to monitor all surrounding vehicles 200 regardless of the position of the surrounding, secondary vehicles 200 within the detection zone 18.

The secondary vehicles 200 may be equipped with various technological capabilities 202 including, but not limited to, blind spot monitoring 202a. For example, the secondary vehicles 200 may display an indicia 220 indicating that the primary vehicle 100 or other secondary vehicles 200 are within a blind spot 204 of the secondary vehicle 200. Both the primary and secondary vehicles 100, 200 are equipped with turn indicators 106, 206 that may be utilized to indicate to other vehicles 100, 200 a potential movement of the vehicles 100, 200. For example, the secondary vehicle 200 may utilize a turn indicator 206 to notify the primary vehicle 100 of a lane change 208. In some instances, described herein, the secondary vehicle 200 may execute a lane change 208 independently of operating the turn indicators 206. In other instances, the secondary vehicle 200 may execute the turn indicators 206 during execution of the lane change 208.

With further reference to FIGS. 1-3, the monitoring system 10 may be communicatively coupled to a back-office server 300 to receive crowdsourced data 302. For example, the controller 12 of the monitoring system 10 may be communicatively coupled to the back-office server 300 via a network 304 to receive the crowdsourced data 302. The crowdsourced data 302 may include lane change areas 306, vehicle movements 308, the technological capabilities 202 of the secondary vehicles 200, one or more identified erratic vehicles 200, and frequency data 310 relative to the lane change areas 306 of the roadway 210. For example, exit areas 212 of roadways 210 may have a higher or greater frequency of lane changes 208 independent of turn indicator 206 execution. With respect to the technological capabilities 202 of the secondary vehicles 200, the sensors 110 may capture, as sensor data 112, specifications 112a of the secondary vehicle 200. The monitoring system 10 may communicate the specifications 112a with the back-office server 300, and the back-office server 300 may notify the monitoring system 10 as to the technological capabilities 202 of the secondary vehicle 200. The monitoring system 10 may utilize the technological capabilities 202 to execute the monitoring application 14, as described in detail below.

The monitoring application 14 is executed by data processing hardware 20 of the controller 12. The controller 12 also includes memory hardware 22 that is in communication with the data processing hardware 20. The memory hardware 22 stores instructions that, when executed on the data processing hardware 20, cause the data processing hardware 20 to perform operations, described herein. The monitoring application 14 includes a blind spot monitoring function 30 that utilizes blind spot data 32 to determine whether the primary vehicle 100 is within a blind spot 204 of the secondary vehicle 200. The monitoring application 14 also includes an occupant monitoring function 40 that monitors occupants of the secondary vehicle 200, described below.

Referring still to FIGS. 1-4, the monitoring application 14 monitors surrounding vehicles 200 along a roadway 210 regardless of whether the secondary vehicles 200 are in the detection zone 18. The detection zone 18 is utilized by the monitoring application 14 to determine a priority of execution, as more than one secondary vehicle 200 may be monitored during a single operation of the primary vehicle 100. For example, the monitoring application 14 is configured to determine whether a secondary vehicle 200 is present in front of the primary vehicle 100, but with a lane between the primary vehicle 100 and the secondary vehicle 200. The position of the secondary vehicle 200 may at least partially inform the operations executed by the monitoring application 14. For example, the determination of whether the primary vehicle 100 is within a blind spot 204 of the secondary vehicle 200 may have increased priority if the secondary vehicle 200 is in a lane 214 next to an operating lane 216 as compared to a lane 214 spaced apart from the operating lane 216. Regardless of the lane 214 of the secondary vehicle 200 relative to the operating lane 216, the monitoring application 14 monitors the secondary vehicle 200. For example, the monitoring application 14 executes the blind spot monitoring function 30 to determine whether the primary vehicle 100 is positioned in a blind spot 204 of the secondary vehicle 200.

The sensor data 112 received by the monitoring application 14 includes blind spot data 32, which may indicate that the primary vehicle 100 is positioned in a blind spot 204 of the secondary vehicle 200. For example, the sensors 110 may capture a lighted indicia 220 that is configured to indicate the presence of a vehicle 100, 200 within the blind spot 204 of the secondary vehicle 200. The lighted indicia 220 is communicated as blind spot data 32 of the sensor data 112 to the monitoring application 14 and utilized by the blind spot monitoring function 30. In some instances, the primary vehicle 100 may be outside of the blind spot 204 of the secondary vehicle 200, such that potential indicia 220 may be deactivated or the secondary vehicle 200 may not be equipped with blind spot monitoring 202a. As mentioned above, the monitoring application 14 may communicate the specifications 112a, via the sensor data 112, with the back-office server 300 to determine whether the secondary vehicle 200 is equipped with blind spot monitoring 202a. For example, the back-office server 300 may evaluate a make, model year, and/or trim (i.e., the specifications 112a) of the secondary vehicle 200 to determine whether the technological capabilities 202 include blind spot monitoring 202a.

If the secondary vehicle 200 is not equipped with blind spot monitoring 202a, the monitoring application 14 may heighten the blind spot monitoring function 30. For example, the monitoring application 14 is configured to issue alerts 24 based on the various functions of the monitoring application 14. The alerts 24 may be categorized based on an alert threshold 26 and may range between a low-level alert 24a, a medium-level alert 24b, and a high-level alert 24c. The driver may configure or set the alert threshold 26 and may continually adjust (i.e., increase or decrease) the alert threshold 26 depending on the preferences of the driver. In other instances, a minimum alert threshold 26 may be preconfigured in the monitoring application 14 during initial configuration of the monitoring system 10. In the example of the secondary vehicle 200 not being equipped with the blind spot monitoring 202a, the monitoring application 14 may issue a high-level alert 24c, rather than a low-level or medium-level alert 24a, 24b, to alert a driver of the primary vehicle 100 that the secondary vehicle 200 may execute a lane change 208 without being aware of the position of the primary vehicle 100 in the blind spot 204.

The monitoring application 14 may issue the alert 24 in response to the primary vehicle 100 being in the blind spot 204 of the secondary vehicle 200. In some instances, the primary vehicle 100 may be autonomous or semi-autonomous. For example, the primary vehicle 100 may be equipped with an advanced-driver assistance system (ADAS) 108 that may accelerate or decelerate the primary vehicle 100 in response to the alert 24. In other instances, the alert 24 may include a recommendation for the driver of the primary vehicle 100 to position the primary vehicle 100 outside of the blind spot 204 of the secondary vehicle 200. In some instances, the back-office server 300 may not have the data on the technological capabilities 202 of the secondary vehicle 200, such that the monitoring application 14 may proceed as if the secondary vehicle 200 is not equipped with the blind spot monitoring 202a.

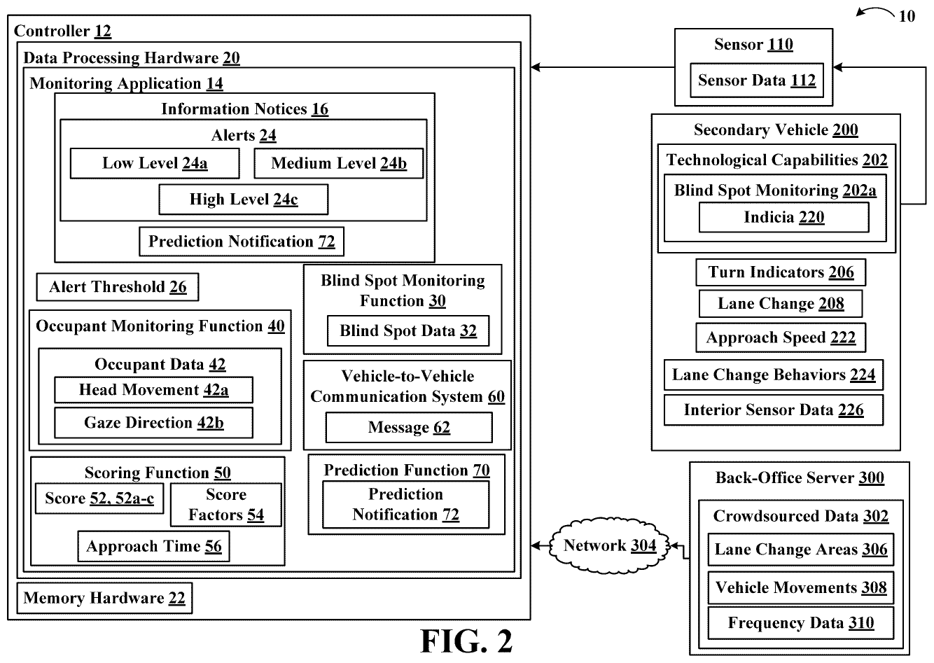

Referring now to FIGS. 2-5, the monitoring application 14 may issue a low-level alert 24a based on the blind spot data 32 to notify the driver of the primary vehicle 100 that the primary vehicle 100 is in a blind spot 204 of the secondary vehicle 200. The low-level alert 24a may generally correspond to the secondary vehicle 200 being equipped with blind spot monitoring 202a. The low-level alert 24a may be utilized by the monitoring system 10 to keep the driver of the primary vehicle 100 informed of the position of the primary vehicle 100 relative to the secondary vehicle 200. In some instances, occupants of the secondary vehicle 200 may exhibit movements that may indicate or forecast a potential lane change 208.

The monitoring application 14 utilizes the occupant monitoring function 40 to detect movement of an occupant of the secondary vehicle 200 based on the sensor data 112. For example, the occupant monitoring function 40 utilizes occupant data 42, received as part of the sensor data 112, to assess the occupant of the secondary vehicle 200 for a potential lane change 208. The occupant data 42 includes head movements 42a and a gaze direction 42b of an occupant of the secondary vehicle 200.

The occupant monitoring function 40 evaluates the occupant data 42 to detect a pattern of movements that correspond with executing a lane change 208. For example, a head of an occupant of the secondary vehicle 200 may repeatedly rotate (i.e., a predetermined number of rotations or head movements 42a) and/or the occupant may repeatedly direct a gaze toward the occupied, operating lane 216 of the primary vehicle 100. If the primary vehicle 100 is in the blind spot 204, the occupant of the secondary vehicle 200 may be unable to identify the primary vehicle 100 using visual cues. Thus, the monitoring application 14 issues the alert 24 upon detection of the primary vehicle 100 in the blind spot 204. The monitoring application 14 utilizes the occupant monitoring function 40 to determine whether to escalate the alert 24. In other instances, the primary vehicle 100 may be outside of the blind spot 204, but a lane change 208 by the secondary vehicle 200 may be close to the position of the primary vehicle 100 in the occupied lane 216. As a result, the monitoring application 14 may issue the alert 24 regardless of the position of the primary vehicle 100 within the blind spot 204 of the secondary vehicle 200. Stated differently, the monitoring application 14 is configured to issue the alert 24 based on at least one of the blind spot monitoring function 30 and the occupant monitoring function 40.

The monitoring application 14 may utilize a scoring function 50 to generate a score 52 based on the occupant data 42 and the blind spot data 32. The score 52 may include a low score 52a, a medium score 52b, and a high score 52c. The scoring function 50 may also utilize the navigation data 122 from the navigation application 120 and/or the crowdsourced data 302 from the back-office server 300 to generate the score 52. The scoring function 50 evaluates score factors 54 to generate the score 52, which is informed by the blind spot data 32, the occupant data 42, the navigation data 122, and/or the crowdsourced data 302. The score factors 54 may also include one or more of repeated lane changes 208 by the secondary vehicle 200 and an approach speed 222 of the secondary vehicle 200. The scoring function 50 determines a likelihood that the secondary vehicle 200 will execute a lane change 208 independent of the turn indicators 206. In other words, the scoring function 50 determines (i.e., generates a score 52) how likely it is that the secondary vehicle 200 will execute a lane change 208 without utilizing the turn indicators 206 of the secondary vehicle 200. The score 52 reflects the likelihood that the secondary vehicle 200 may execute a lane change 208 independent of (i.e., without using) the turn indicators 206 of the secondary vehicle 200.

For example, if the approach speed 222 of the secondary vehicle 200 is high and/or the sensor data 112 reflects that the secondary vehicle 200 has executed multiple lane changes 208 within a predetermined approach time 56, the scoring function 50 may generate a high score 52c. In response to a high score 52c, the monitoring application 14 may execute a high alert 24c, as the score 52 generally reflects a combination of each of the blind spot data 32, the occupant monitoring data 42, navigation data 122, and/or crowdsourced data 302. The greater the number of score factors 54 detected, the higher the score 52c, which informs the level of alert 24 to issue by the monitoring application 14. For example, if the secondary vehicle 200 exhibits lane change behaviors 224, captured as sensor data 112, the monitoring application 14 may inform whether the secondary vehicle 200 may execute a lane change 208 without using a turn indicator 206.

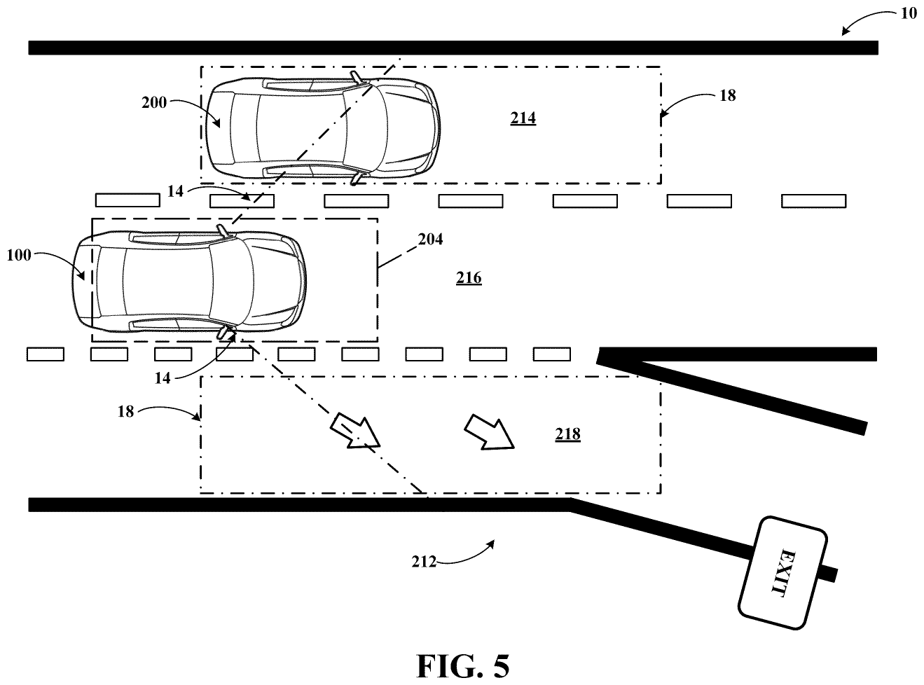

As mentioned above, the scoring function 50 may utilize crowdsource data 302 to inform the score factors 54. FIG. 5 illustrates one exemplary situation of a secondary vehicle 200 in a first lane 214 and the primary vehicle 100 in an occupied, second lane 216 next to an exit lane 218. The crowdsourced data 302 may include frequency data 310 corresponding to the frequency of lane changes 208 occurring in a particular area (i.e., an exit area 212) of a roadway 210. For example, the monitoring application 14 may utilize the navigation data 122 to determine a position of the primary vehicle 100 on the roadway 210 and compare the navigation data 122 with the crowdsourced data 302 corresponding to the position of the primary vehicle 100. In the illustrated example of FIG. 5, the monitoring application 14 may receive the frequency data 310 corresponding to the exit area 212 that includes the exit lane 218, and the scoring function 50 may increase the score 52 based on the frequency data 310.

While illustrated and described with respect to an exit lane 218, the frequency data 310 may include crowdsourced data 302 from other areas of a roadway 210 including, but not limited to, on-ramps, off-ramps, merge lanes, lane shifts, lane expansions, and any other roadway 210 feature that may result in a higher likelihood that a secondary vehicle 200 may execute a lane change 208. In some instances, the primary vehicle 100 may be equipped with a vehicle-to-vehicle communication system 60. The vehicle-to-vehicle communication system 60 may be configured to receive messages or data 62 directly from a secondary vehicle 200. The messages 62 may include various information pertaining to the secondary vehicle 200 that may be utilized by the monitoring application 14 in executing the various functions 30, 40, 50 of the monitoring application 14. For example, the message 62 may include a route of the secondary vehicle 200 that may indicate that the secondary vehicle 200 needs to access the exit lane 218 (FIG. 5). The driver or ADAS 108 of the primary vehicle 100 may adjust the position of the primary vehicle 100 in response to the message 62 to accommodate room for the secondary vehicle 200 to execute the lane change 208. In another example, the message 62 may include the technological capabilities 202 and/or interior sensor data 226 of the secondary vehicle 200, which may assist in improving the accuracy of the monitoring application 14 with respect to generating the score 52 based on the blind spot monitoring function 30 and the occupant monitoring function 40.

The monitoring application 14 is also equipped with a prediction function 70 to predict whether the secondary vehicle 200 is likely to execute a lane change 208 without using a turn indicator 206, which may also be informed by the score factors 54. Thus, the prediction function 70 may be utilized to identify a predicted lane change 208. The prediction function 70 may generate a prediction notification 72 based on the score 52. For example, the prediction function 70 utilizes the score 52 generated by the scoring function 50 to inform the prediction notification 72. The prediction notification 72 includes predicting a lane change 208 of the secondary vehicle 200 independent of turn indicators 206, such that the driver of the primary vehicle 100 is made aware of the likelihood that the secondary vehicle 200 may execute a lane change 208. The prediction notification 72 may be presented to the driver at the display 104 of the infotainment unit 102 in combination with the alert 24, as the information notices 16. In other instances, the predication notification 72 may be provided at the display 104 prior to or following issuing the alert 24.

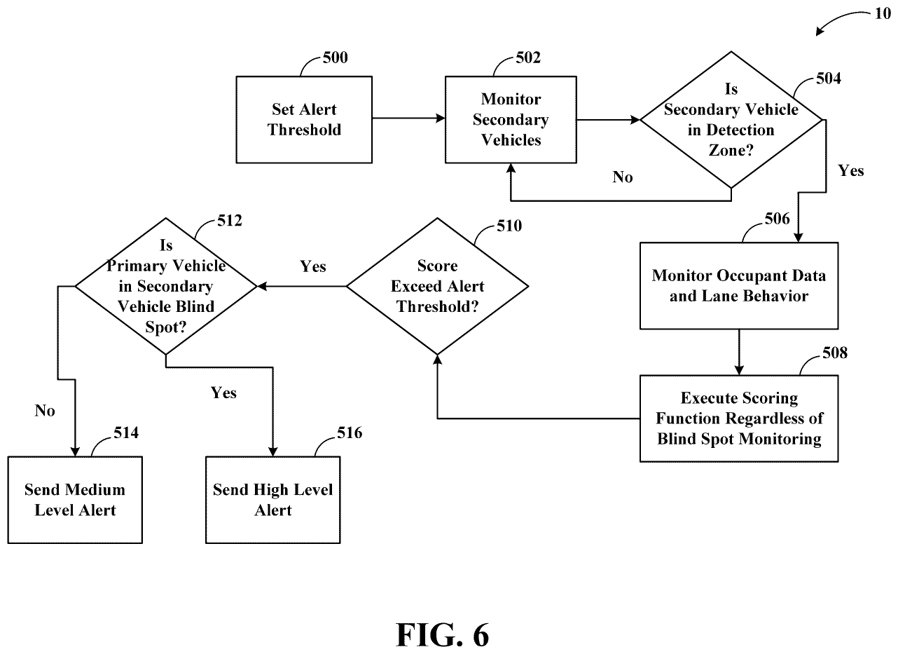

With reference now to FIGS. 1-7, methods of operating the monitoring system 10 are illustrated in various flow diagrams. With specific reference to FIG. 6, an alert threshold 26 is set, at 500, and the monitoring system 10 monitors, at 502, secondary vehicles 200. The monitoring system 10 determines, at 504, if the secondary vehicle 200 is in the detection zone 18. If the secondary vehicle 200 is outside of the detection zone 18, then the monitoring system 10 continues to monitor the secondary vehicle 200. If the secondary vehicle 200 is in the detection zone 18, then the monitoring system 10 monitors, at 506, the occupant data 42 and lane change behaviors 224.

The monitoring system 10 executes, at 508, the scoring function 50 regardless of the blind spot monitoring data 32, as the secondary vehicle 200 is in the detection zone 18. The monitoring system 10 determines, at 510, whether the score 52 exceeds the alert threshold 26. If the score 52 does not exceed the alert threshold 24, then the monitoring system 10 returns to monitoring the secondary vehicle 200, at 502. If the score 52 exceeds the alert threshold 26, then the monitoring system 10, at 512, determines whether the primary vehicle 100 is in the blind spot 204 of the secondary vehicle 200. If the primary vehicle 100 is not in the blind spot 204, then the monitoring system 10 issues, at 514, a medium alert 24b, based on the score 52 exceeding the alert threshold 26 but not being in the blind spot 204. If the primary vehicle 100 is in the blind spot 204, the monitoring system 10 issues, at 516, a high alert 24c.

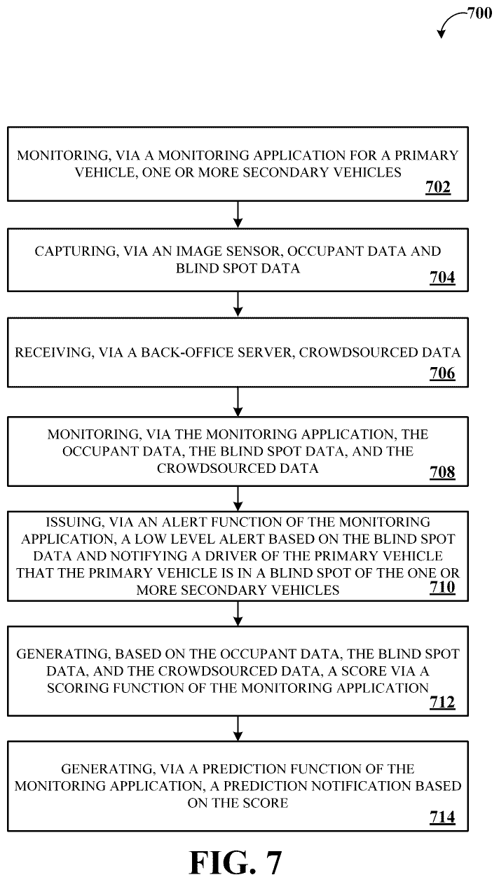

With specific reference to FIG. 7, the monitoring system 10 executes a method 700. At 702, the monitoring system 10 monitors, via a monitoring application 14 for a primary vehicle 100, one or more secondary vehicles 200. The monitoring system 10 captures, at 704, via an image sensor 110, occupant data 42 and blind spot data 32. The monitoring system, at 706, receives, via a back-office server 300, crowdsourced data 302 and monitors, at 708, via the monitoring application 14, the occupant data 42, the blind spot data 32, and the crowdsourced data 302. The monitoring application 14 issues, at 710 a low-level alert 24a based on the blind spot data 32 and notifies a driver of the primary vehicle 100 that the primary vehicle 100 is in a blind spot 204 of the one or more secondary vehicles 200. The monitoring system 10 generates, at 712, based on the occupant data 42, the blind spot data 32, and the crowdsourced data 302, a score 52 via a scoring function 50 of the monitoring application 14. At 714, the monitoring system 10 generates, via a prediction function 70 of the monitoring application 14, a prediction notification 72 based on the score 52.

Referring again to FIGS. 1-7, the monitoring system 10 advantageously assists drivers of vehicles 100 to monitor surrounding vehicles 200 and minimize encounters of unexpected lane changes 208. The scoring function 50 provides a ranking system for the monitoring system 10 to assist in predicting the potential movement of the surrounding vehicles 200 based on a variety of data 32, 42, 122, 302. While some of the data (i.e., the crowdsourced data 302 and the navigation data 122) is received by the monitoring system 10 externally from the vehicle 100, the monitoring system 10 is advantageously configured to parse and evaluate sensor data 112 (i.e., image data 112) to selectively categorize the sensor data 112 as blind spot data 32 and occupant data 42. Thus, the monitoring system 10 may utilize sensors 110 that may come preassembled with the vehicle 100 by harnessing the sensor data 110 to be utilized with the monitoring application 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A monitoring system for a vehicle, the monitoring system comprising:
a plurality of sensors configured to capture sensor data;
a navigation application including navigation data;
an infotainment unit including a display; and
a controller communicatively coupled with each of the plurality of sensors, the navigation application, and the infotainment unit, the controller including data processing hardware configured to execute a monitoring application based at least one of the sensor data and the navigation data, the monitoring application configured to monitor a detection zone of the vehicle for one or more surrounding vehicles and configured to predict a lane change of the one or more surrounding vehicles and configured to issue an alert at the display of the infotainment unit in response to the predicted lane change.

2. The monitoring system of claim 1, wherein the monitoring application includes a blind spot monitoring function configured to determine the vehicle is positioned within a blind spot of the one or more surrounding vehicles based on the sensor data.

3. The monitoring system of claim 2, wherein the monitoring application is configured with an occupant monitoring function, the occupant monitoring function being configured to detect a movement of an occupant of the one or more surrounding vehicles based on the sensor data.

4. The monitoring system of claim 3, wherein the monitoring application is configured to issue the alert based on at least one of the blind spot monitoring function and the occupant monitoring function.

5. The monitoring system of claim 1, wherein the monitoring application is configured to issue the alert in response to a detected surrounding vehicle and the navigation data, the navigation data including an exit area of a roadway.

6. The monitoring system of claim 1, wherein the monitoring application is configured to monitor a lane change behavior of the one or more surrounding vehicles and determine the predicted lane change based on the monitored lane change behavior.

7. The monitoring system of claim 1, wherein the controller is communicatively coupled with a back-office server and is configured to receive crowdsourced data from the back-office server, the crowdsourced data including at least one of lane change areas and vehicle movements.

8. The monitoring system of claim 1, wherein the plurality of sensors includes an image sensor and the sensor data includes image data.

9. A computer-implemented method when executed by data processing hardware causes the data processing hardware to perform operations comprising:
monitoring, via a monitoring application for a primary vehicle, one or more secondary vehicles;
capturing, via an image sensor, occupant data and blind spot data;
receiving, via a back-office server, crowdsourced data;
monitoring, via the monitoring application, the occupant data, the blind spot data, and the crowdsourced data;
issuing, via the monitoring application, a low-level alert based on the blind spot data and notifying a driver of the primary vehicle that the primary vehicle is in a blind spot of the one or more secondary vehicles;
generating, based on the occupant data, the blind spot data, and the crowdsourced data, a score via a scoring function of the monitoring application;
generating, via a prediction function of the monitoring application, a prediction notification based on the score.

10. The method of claim 9, wherein generating the prediction notification includes predicting a lane change of the one or more secondary vehicles independent of turn indicators.

11. The method of claim 9, wherein generating the score includes evaluating score factors, the score factors including one or more of repeated lane changes, an approach speed, navigation data, and the crowdsourced data.

12. The method of claim 9, wherein the crowdsourced data includes technological capabilities of the one or more secondary vehicles, identified erratic vehicles, and frequency data of exit areas of a roadway.

13. The method of claim 9, wherein generating the score includes determining a likelihood of the one or more secondary vehicles executing a lane change independent of turn indicators.

14. The method of claim 9, wherein monitoring the occupant data includes monitoring a head movement and gaze direction of an occupant of the one or more secondary vehicles.

15. A monitoring system for a vehicle, the monitoring system comprising:
data processing hardware; and
memory hardware in communication with the data processing hardware, the memory hardware storing instructions that when executed on the data processing hardware cause the data processing hardware to perform operations comprising:
monitoring, via a monitoring application for a vehicle, one or more secondary vehicles;
capturing, via an image sensor, occupant data and blind spot data;
receiving, via a back-office server, crowdsourced data;
monitoring, via the monitoring application, the occupant data, the blind spot data, and the crowdsourced data;
generating, based on the occupant data, the blind spot data, and the crowdsourced data, a score via a scoring function of the monitoring application;
generating, via a prediction function of the monitoring application, a prediction notification based on the score.

16. The monitoring system of claim 15, wherein generating the prediction notification includes predicting a lane change of the one or more secondary vehicles independent of turn indicators.

17. The monitoring system of claim 15, wherein generating the score includes evaluating score factors, the score factors including one or more of repeated lane changes, an approach speed, navigation data, and the crowdsourced data.

18. The monitoring system of claim 15, wherein the crowdsourced data includes technological capabilities of the one or more secondary vehicles, identified erratic vehicles, and frequency data of exit areas of a roadway.

19. The monitoring system of claim 15, wherein generating the score includes determining a likelihood of the one or more secondary vehicles executing a lane change independent of turn indicators.

20. The monitoring system of claim 15, wherein monitoring the occupant data includes monitoring a head movement and gaze direction of an occupant of the one or more secondary vehicles.
